(19) United States
(12) Patent Application Publication
(10) Pub. No.: US 2025/0123910 A1
(43) Pub. Date: Apr. 17, 2025

(54) DEPENDENCY APPLICATION PROGRAMMING INTERFACE FOR REPRESENTATIONAL STATE TRANSFER TRANSACTIONS

(71) Applicant: DELL PRODUCTS L.P., Round Rock, TX (US)

(72) Inventors: Ramya Ramakrishnan, Bangalore (IN); Abhirup Seal, Bangalore (IN); Sunil Khannade, Bangalore (IN)

(21) Appl. No.: 18/485,177

(22) Filed: Oct. 11, 2023

(51) Int. Cl. G06F 9/54

(52) U.S. Cl. CPC G06F 9/547

(57) ABSTRACT

A system determines whether an API request has a dependency prior to processing the API request. If the dependency is unmet, then a user may instruct the system to automatically resolve the dependency prior to processing the API request. The user may also resolve the dependency manually. If the dependency is resolved, then the system transmits a response based on the processing of the API request that includes information associated with the dependency.

### FIELD OF THE DISCLOSURE

The present disclosure generally relates to information handling systems, and more particularly relates to a dependency application programming interface for representational state transfer transactions.

### BACKGROUND

As the value and use of information continues to increase, individuals and businesses seek additional ways to process and store information. One option is an information handling system. An information handling system generally processes, compiles, stores, or communicates information or data for business, personal, or other purposes. Technology and information handling needs and requirements can vary between different applications. Thus, information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, networking systems, and mobile communication systems. Information handling systems can also implement various virtualized architectures. Data and voice communications among information handling systems may be via networks that are wired, wireless, or some combination.

### SUMMARY

A system determines whether an API request has a dependency prior to processing the API request. If the dependency is unmet, then a user may instruct the system to automatically resolve the dependency prior to processing the API request. The user may also resolve the dependency manually. If the dependency is resolved, then the system transmits a response based on the processing of the API request that includes information associated with the dependency.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram illustrating an information handling system according to an embodiment of the present disclosure;

FIG. 2 is a block diagram of an environment for a dependency application programming interface (API) for representational state transfer (REST) transactions, according to an embodiment of the present disclosure;

FIG. 3 is a flowchart of a method to determine dependencies of a RESTful API request, according to an embodiment of the present disclosure;

FIG. 4 is a flowchart of a method for a dependency API for REST transactions, according to an embodiment of the present disclosure;

FIGS. 5-7 are examples of responses to API requests that show dependency API for REST transactions syntax, according to an embodiment of the present disclosure;

FIG. 8 shows an example of a portion of a response that includes information associated with a status of the dependencies of an API request, according to an embodiment of the present disclosure;

FIG. 9 shows an example of a portion of a response that includes information associated with the resolution of unmet dependencies, according to an embodiment of the present disclosure; and

FIG. 10 is a flowchart of a method for automatically resolving a dependency for API requests, according to an embodiment of the present disclosure.

The use of the same reference symbols in different drawings indicates similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

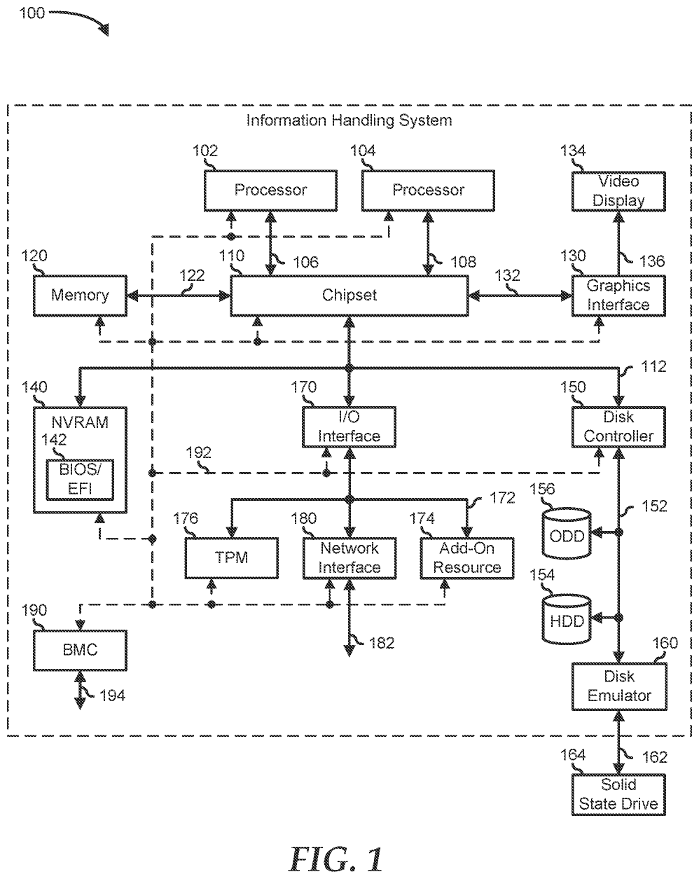

FIG. 1 illustrates an embodiment of an information handling system 100 including processors 102 and 104, a chipset 110, a memory 120, a graphics adapter 130 connected to a video display 134, a non-volatile RAM (NV-RAM) 140 that includes a basic input and output system/extensible firmware interface (BIOS/EFI) module 142, a disk controller 150, a hard disk drive (HDD) 154, an optical disk drive 156, a disk emulator 160 connected to a solid-state drive (SSD) 164, an input/output (I/O) interface 170 connected to an add-on resource 174 and a trusted platform module (TPM) 176, a network interface 180, and a baseboard management controller (BMC) 190. Processor 102 is connected to chipset 110 via processor interface 106, and processor 104 is connected to the chipset via processor interface 108. In a particular embodiment, processors 102 and 104 are connected together via a high-capacity coherent fabric, such as a HyperTransport link, a QuickPath Interconnect, or the like. Chipset 110 represents an integrated circuit or group of integrated circuits that manage the data flow between processors 102 and 104 and the other elements of information handling system 100. In a particular embodiment, chipset 110 represents a pair of integrated circuits, such as a northbridge component and a southbridge component. In another embodiment, some or all of the functions and features of chipset 110 are integrated with one or more of processors 102 and 104.

Memory 120 is connected to chipset 110 via a memory interface 122. An example of memory interface 122 includes a Double Data Rate (DDR) memory channel and memory 120 represents one or more DDR Dual In-Line Memory Modules (DIMMs). In a particular embodiment, memory interface 122 represents two or more DDR channels. In another embodiment, one or more of processors 102 and 104 include a memory interface that provides a dedicated memory for the processors. A DDR channel and the connected DDR DIMMs can be in accordance with a particular DDR standard, such as a DDR3 standard, a DDR4 standard, a DDR5 standard, or the like.

Memory 120 may further represent various combinations of memory types, such as Dynamic Random Access Memory (DRAM) DIMMs, Static Random Access Memory (SRAM) DIMMs, non-volatile DIMMs (NV-DIMMs), storage class memory devices, Read-Only Memory (ROM) devices, or the like. Graphics adapter 130 is connected to chipset 110 via a graphics interface 132 and provides a video display output 136 to a video display 134. An example of a graphics interface 132 includes a Peripheral Component Interconnect-Express (PCIe) interface and graphics adapter 130 can include a four-lane (x4) PCIe adapter, an eight-lane (x8) PCIe adapter, a 16-lane (x16) PCIe adapter, or another configuration, as needed or desired. In a particular embodiment, graphics adapter 130 is provided down on a system printed circuit board (PCB). Video display output 136 can include a Digital Video Interface (DVI), a High-Definition Multimedia Interface (HDMI), a DisplayPort interface, or the like, and video display 134 can include a monitor, a smart television, an embedded display such as a laptop computer display, or the like.

NV-RAM 140, disk controller 150, and I/O interface 170 are connected to chipset 110 via an I/O channel 112. An example of I/O channel 112 includes one or more point-to-point PCIe links between chipset 110 and each of NV-RAM 140, disk controller 150, and I/O interface 170. Chipset 110 can also include one or more other I/O interfaces, including a PCIe interface, an Industry Standard Architecture (ISA) interface, a Small Computer Serial Interface (SCSI) interface, an Inter-Integrated Circuit (I²C) interface, a System Packet Interface (SPI), a Universal Serial Bus (USB), another interface, or a combination thereof. NV-RAM 140 includes BIOS/EFI module 142 that stores machine-executable code (BIOS/EFI code) that operates to detect the resources of information handling system 100, to provide drivers for the resources, to initialize the resources, and to provide common access mechanisms for the resources. The functions and features of BIOS/EFI module 142 will be further described below.

Disk controller 150 includes a disk interface 152 that connects the disc controller to a hard disk drive (HDD) 154, to an optical disk drive (ODD) 156, and to disk emulator 160. An example of disk interface 152 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 160 permits SSD 164 to be connected to information handling system 100 via an external interface 162. An example of external interface 162 includes a USB interface, an institute of electrical and electronics engineers (IEEE) 1394 (Firewire) interface, a proprietary interface, or a combination thereof. Alternatively, SSD 164 can be disposed within information handling system 100.

I/O interface 170 includes a peripheral interface 172 that connects the I/O interface to add-on resource 174, to TPM 176, and to network interface 180. Peripheral interface 172 can be the same type of interface as I/O channel 112 or can be a different type of interface. As such, I/O interface 170 extends the capacity of I/O channel 112 when peripheral interface 172 and the I/O channel are of the same type, and the I/O interface translates information from a format suitable to the I/O channel to a format suitable to the peripheral interface 172 when they are of a different type. Add-on resource 174 can include a data storage system, an additional graphics interface, a network interface card (NIC), a sound/video processing card, another add-on resource, or a combination thereof. Add-on resource 174 can be on a main circuit board, on separate circuit board, or add-in card disposed within information handling system 100, a device that is external to the information handling system, or a combination thereof.

Network interface 180 represents a network communication device disposed within information handling system 100, on a main circuit board of the information handling system, integrated onto another component such as chipset 110, in another suitable location, or a combination thereof. Network interface 180 includes a network channel 182 that provides an interface to devices that are external to information handling system 100. In a particular embodiment, network channel 182 is of a different type than peripheral interface 172, and network interface 180 translates information from a format suitable to the peripheral channel to a format suitable to external devices.

In a particular embodiment, network interface 180 includes a NIC or host bus adapter (HBA), and an example of network channel 182 includes an InfiniBand channel, a Fibre Channel, a Gigabit Ethernet channel, a proprietary channel architecture, or a combination thereof. In another embodiment, network interface 180 includes a wireless communication interface, and network channel 182 includes a Wi-Fi channel, a near-field communication (NFC) channel, a Bluetooth® or Bluetooth-Low-Energy (BLE) channel, a cellular based interface such as a Global System for Mobile (GSM) interface, a Code-Division Multiple Access (CDMA) interface, a Universal Mobile Telecommunications System (UMTS) interface, a Long-Term Evolution (LTE) interface, or another cellular based interface, or a combination thereof. Network channel 182 can be connected to an external network resource (not illustrated). The network resource can include another information handling system, a data storage system, another network, a grid management system, another suitable resource, or a combination thereof.

BMC 190 is connected to multiple elements of information handling system 100 via one or more management interface 192 to provide out of band monitoring, maintenance, and control of the elements of the information handling system. As such, BMC 190 represents a processing device different from processor 102 and processor 104, which provides various management functions for information handling system 100. For example, BMC 190 may be responsible for power management, cooling management, and the like. The term BMC is often used in the context of server systems, while in a consumer-level device, a BMC may be referred to as an embedded controller (EC). A BMC included in a data storage system can be referred to as a storage enclosure processor. A BMC included in a chassis of a blade server can be referred to as a chassis management controller and embedded controllers included at the blades of the blade server can be referred to as blade management controllers. Capabilities and functions provided by BMC 190 can vary considerably based on the type of information handling system. BMC 190 can operate in accordance with an Intelligent Platform Management Interface (IPMI). Examples of BMC 190 include an Integrated Dell R Remote Access Controller (iDRAC).

Management interface 192 represents one or more out-of-band communication interfaces between BMC 190 and the elements of information handling system 100, and can include a I²C bus, a System Management Bus (SMBus), a Power Management Bus (PMBUS), a Low Pin Count (LPC) interface, a serial bus such as a Universal Serial Bus (USB) or a Serial Peripheral Interface (SPI), a network interface such as an Ethernet interface, a high-speed serial data link such as a PCIe interface, a Network Controller Sideband Interface (NC-SI), or the like. As used herein, out-of-band access refers to operations performed apart from a BIOS/operating system execution environment on information handling system 100, that is apart from the execution of code by processors 102 and 104 and procedures that are implemented on the information handling system in response to the executed code.

BMC 190 operates to monitor and maintain system firmware, such as code stored in BIOS/EFI module 142, option ROMs for graphics adapter 130, disk controller 150, add-on resource 174, network interface 180, or other elements of information handling system 100, as needed or desired. In particular, BMC 190 includes a network interface 194 that can be connected to a remote management system to receive firmware updates, as needed or desired. Here, BMC 190 receives the firmware updates, stores the updates to a data storage device associated with the BMC, and transfers the firmware updates to NV-RAM of the device or system that is the subject of the firmware update, thereby replacing the currently operating firmware associated with the device or system, and reboots information handling system, whereupon the device or system utilizes the updated firmware image.

BMC 190 utilizes various protocols and application programming interfaces (APIs) to direct and control the processes for monitoring and maintaining the system firmware. An example of a protocol or API for monitoring and maintaining the system firmware includes a graphical user interface (GUI) associated with BMC 190, an interface defined by the Distributed Management Taskforce (DMTF) (such as a Web Services Management (WSMan) interface, a Management Component Transport Protocol (MCTP) or, a Redfish® interface), various vendor defined interfaces (such as a Dell EMC Remote Access Controller Administrator (RACADM) utility, a Dell EMC OpenManage Enterprise, a Dell EMC OpenManage Server Administrator (OMSA) utility, a Dell EMC OpenManage Storage Services (OMSS) utility, or a Dell EMC OpenManage Deployment Toolkit (DTK) suite), a BIOS setup utility such as invoked by a “F2” boot option, or another protocol or API, as needed or desired.

In a particular embodiment, BMC 190 is included on a main circuit board (such as a baseboard, a motherboard, or any combination thereof) of information handling system 100 or is integrated onto another element of the information handling system such as chipset 110, or another suitable element, as needed or desired. As such, BMC 190 can be part of an integrated circuit or a chipset within information handling system 100. An example of BMC 190 includes an iDRAC, or the like. BMC 190 may operate on a separate power plane from other resources in information handling system 100. Thus BMC 190 can communicate with the management system via network interface 194 while the resources of information handling system 100 are powered off. Here, information can be sent from the management system to BMC 190 and the information can be stored in a RAM or NV-RAM associated with the BMC. Information stored in the RAM may be lost after power-down of the power plane for BMC 190, while information stored in the NV-RAM may be saved through a power-down/power-up cycle of the power plane for the BMC.

Information handling system 100 can include additional components and additional busses, not shown for clarity. For example, information handling system 100 can include multiple processor cores, audio devices, and the like. While a particular arrangement of bus technologies and interconnections is illustrated for the purpose of example, one of skill will appreciate that the techniques disclosed herein are applicable to other system architectures. Information handling system 100 can include multiple central processing units (CPUs) and redundant bus controllers. One or more components can be integrated together. Information handling system 100 can include additional buses and bus protocols, for example, I²C and the like. Additional components of information handling system 100 can include one or more storage devices that can store machine-executable code, one or more communications ports for communicating with external devices, and various input and output (I/O) devices, such as a keyboard, a mouse, and a video display.

For purposes of this disclosure, information handling system 100 can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 100 can be a personal computer, a laptop computer, a smartphone, a tablet device or other consumer electronic device, a network server, a network storage device, a switch, a router, or another network communication device, or any other suitable device and may vary in size, shape, performance, functionality, and price. Further, information handling system 100 can include processing resources for executing machine-executable code, such as processor 102, a programmable logic array (PLA), an embedded device such as a System-on-a-Chip (SoC), or other control logic hardware. Information handling system 100 can also include one or more computer-readable media for storing machine-executable code, such as software or data.

Various interfaces such as Redfish® or WSMan are typically used in managing servers. In some embodiments, one or more of the interfaces use web-like or representational state transfer (REST) compliant APIs to provide a scalable foundation for distributed management of the servers. The Redfish® API maintained by the Distributed Management Task Force is an example of a REST-compliant or RESTful API. For example, to perform server configurations and/or operations, a user typically uses a hypertext transfer protocol (HTTP) GET, POST, PATCH, and PUT request.

For successful server configurations and operations, in addition to providing a correct payload, certain dependencies may also have to be resolved. The dependencies can vary from one server configuration to another. Generally, the user needs additional information to resolve the dependencies. For example, a user may go through several pieces of documentation, such as user guides, API guides associated with a service, whitepapers, etc. to identify the dependencies and their order if any which is time-consuming. In addition, these documents are typically generic and are not curated for a particular system or environment. Even with a correct payload, a service typically returns a generic response with minimal details if any on the issue or information on how to fix dependency issues. Thus, it would be advantageous for a system and method to provide configuration-specific dependencies and resolutions proactively.

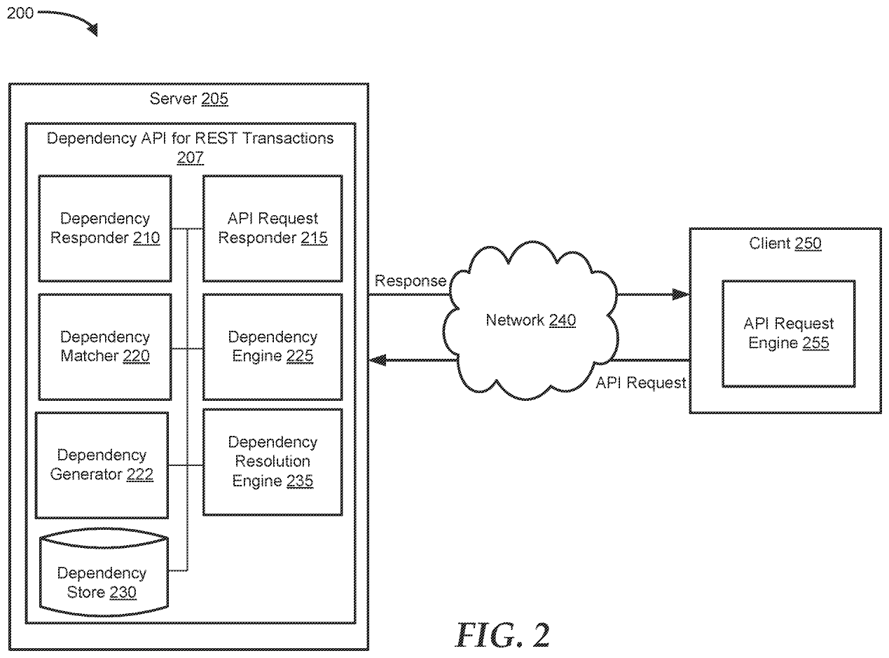

FIG. 2 illustrates an environment 200 for dependency API for REST transactions. Environment 200 includes a server 205, a network 240, and a client 250. Client 250 includes an API request engine 255. Server 205 includes a dependency API for REST transactions 207 which further includes a dependency responder 210, an API request responder 215, a dependency matcher 220, a dependency generator 222, a dependency engine 225, a dependency store 230, and a dependency resolution engine 235. API request responder 215 may include a module for each one of the HTTP APIs. For example, API request responder 215 may include a GET request responder, a PATCH request responder, a POST request responder, and a DELETE request responder. The components of environment 200 may be implemented in hardware, software, firmware, or any combination thereof. The components shown are not drawn to scale and environment 200 may include additional or fewer components. In addition, connections between components may be omitted for descriptive clarity.

Client 250, which is similar to information handling system 100 of FIG. 1, maybe a desktop computer, a laptop computer, a tablet computer, a handheld device, a cellular phone, a notebook computer, or any suitable information handling system. Client 250 may communicate with server 205 through network 240 via one or more protocols, such as HTTP, HTTP secure, file transfer protocol, common internet file system, independent computing architecture protocol, remote desktop protocol, or any suitable protocol or combination of protocols. Client 250 may access software resources provided by server 205, such as operating systems, add-ons, content, or any other suitable data, applications, or images via API requests, also referred to herein simply as API requests. In one embodiment, client 250 or in particular, API request engine 255 may submit or transmit an API request to server 205 via network 240. API request engine 255 may be part of a client application that communicates with server 205.

Server 205, which is similar to information handling system 100 of FIG. 1, may include one or more of a computing device, a desktop computer, a laptop computer, a database, a corporate server, a repository server, a configuration application server, a domain name system server, a dynamic host configuration protocol server, a virtual machine, a desktop session, a published application, a Redfish® server, an application server, or any suitable information handling system. In performing server configurations or operations, users typically use HTTP GET, POST, PATCH, or PUT API requests.

Certain operations associated with the HTPP GET, POST, PATCH, or PUT API requests may have dependencies to be met. For example, to enable a local user in one system, a username and password for that user may need to be configured. Dependencies can vary from one configuration to another configuration or from one system to another system. For example, to enable the local user in another system, only the username for that user may need to be configured. The password may be required at a point of login of the user. Accordingly, dependency API for REST transactions may be configured to automatically and proactively provide configuration-specific dependencies via dependency API for REST transactions 207. In particular, the present disclosure provides a set of resource-level configurations that the current resource depends on and reports whether each of the dependencies is met. Thus, the present disclosure curates information associated with the dependency according to a target system and provides target system-specific resolutions.

Dependency API for REST transactions 207 may be configured to provide a resource-level configuration that a resource depends on and reports whether each of the dependencies is met. A GET dependencies request using a format, such as: <target resource URI>/dependencies may be used to retrieve the resource-level configuration dependencies. This may be performed proactively without calling the actual API request instead of being reactive and failing the actual API request call. For example, prior to executing the API request, dependency API for REST transactions 207 may first determine the dependencies associated with the API request.

Dependency API for REST transactions 207 may also be configured to provide a URI as part of an HTTP link header of a response to the GET dependencies request for the supported resource using a format, such as Link: <target REST URI/dependencies>; rel=related resource. For API requests other than the GET dependencies request, the URI can be embedded in an error message included in the response. In addition, dependency API for REST transactions 207 may provide an end-to-end experience for the user and/or client and adapt in real-time to changes in configuration settings or other dependencies in real-time, such as by resolving unmet dependencies.

API request responder 215 may be configured to process API requests from API request engine 255 from client 250 via network 240. An API request may be transmitted by a user or an application. The API request may be one of a POST, GET, PUT, PATCH, and DELETE request. API request responder 215 may be configured to retrieve dependencies associated with the API request as part of processing the API request. Accordingly, in one embodiment, API request responder 215 may transmit a request to retrieve the dependencies to dependencies matcher 220.

The retrieve dependencies request may be performed by dependencies matcher 220 to determine the dependencies of the API request prior to API request responder 215 performing the actual API request. For example, dependencies matcher 220 may retrieve the dependencies associated with the API request from dependency store 230. Dependency matcher 220 may send the identified dependencies to dependency engine 225. Dependency engine 225 may be configured to determine whether the dependencies are met or unmet. For example, dependency engine 225 may query one or more configurations, BIOS, and other settings associated with the API request. In one particular example, dependency engine 225 may query BIOS settings of server 205 to determine whether secure boot is enabled in server 205. Dependency engine 225 may compare a value from the query to an expected value specified in the API request and/or dependency store 230.

If the value from the query is the same as the expected value of the dependency, then the dependency is met. If the value from the query is not the same as the expected value of the dependency, then the dependency is unmet. If the dependencies of the API request are met, then the API request may be processed. Otherwise, unmet dependencies may be resolved prior to processing the API request. For example, the user may instruct the system to automatically resolve an issue associated with an unmet dependency or resolve the issue manually. In one particular example, an override may be provided for the user to select whether to resolve the dependency issue manually. Otherwise, the system may automatically resolve the dependency issue. Dependency resolution engine 235 may be configured to process or configure the configuration, BIOS, and other settings associated with the unmet dependencies. Dependency resolution engine 235 may also be configured to download and install resource dependencies.

Dependency engine 225 may determine whether the unmet dependencies are now met or still unmet and notify dependency engine 225 of an outcome. If the unmet dependencies are still unmet, the dependencies responder may transmit a response with an error associated with the unmet dependencies. The response may also include a suggestion to resolve the unmet dependencies. The user or the application may also transmit a GET dependencies request by itself prior to transmitting the RESTful API request. This allows the user or the application to determine whether the dependencies of the API request are met prior to transmitting the RESTful API request. In one example, dependency responder 210 may receive the GET dependencies request and transmit the request to dependency generator 222 which may retrieve the dependencies by querying dependency store 230. As such, dependency generator 222 may perform functions similar to dependency matcher 220. Dependency store 230 may transmit the dependencies to dependency engine 225 which may determine whether the dependencies are met or unmet. Dependency resolution engine 235 may resolve unmet dependencies if any.

Network 240 may be a public network, such as the Internet, a physical private network, a wireless network, a virtual private network, or any combination thereof. Dependency store 230 may be a database or a collection of files that is a central repository of dependency information that dependency matcher 220 may retrieve, store, and/or utilize. The repository may include mapping of resource-level configurations that one or more resources depend on.

Those of ordinary skill in the art will appreciate that the configuration, hardware, and/or software components of environment 200 depicted in FIG. 2 may vary. For example, the illustrative components within environment 200 are not intended to be exhaustive but rather are representative to highlight components that can be utilized to implement aspects of the present disclosure. For example, other devices and/or components may be used in addition to or in place of the devices/components depicted. The depicted example does not convey or imply any architectural or other limitations with respect to the presently described embodiments and/or the general disclosure. In the discussion of the figures, reference may also be made to components illustrated in other figures for continuity of the description.

It should be noted that although embodiments herein may be described within the context of Redfish® API calls, aspects of the present disclosure are not so limited. A person of skill in the art will appreciate that the teachings described herein are applicable to other RESTful API requests and/or services and may benefit from using the teachings described herein. Accordingly, the aspects of the present disclosure may be applied or adapted for use in many other contexts. Accordingly, the response described in this disclosure may be of various formats, such as a JavaScript Object Notation, Extensible Markup Language, or other suitable formats.

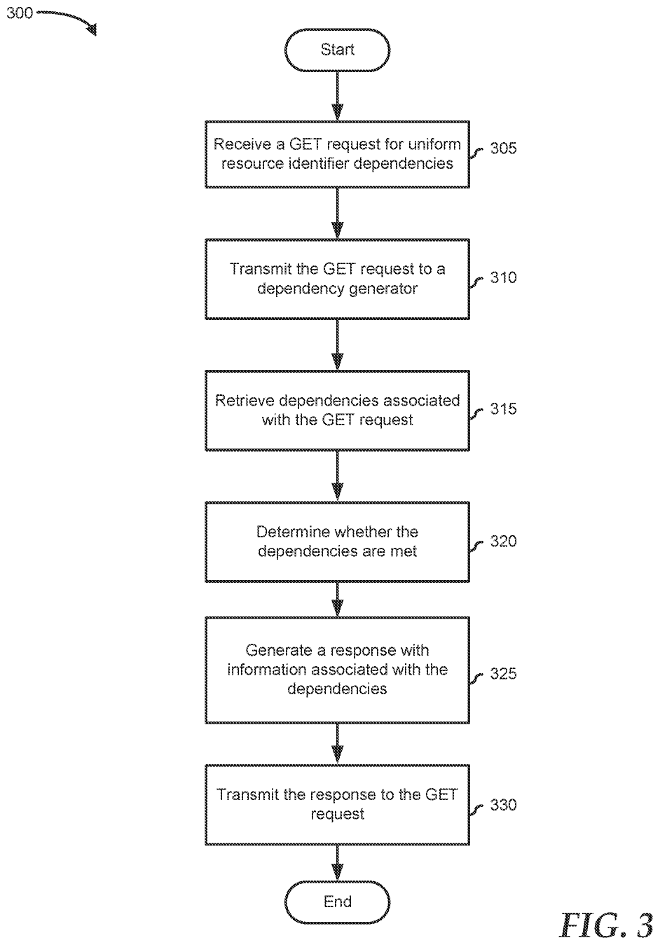

FIG. 3 shows a flowchart of a method 300 to determine dependencies of a RESTful API request. Method 300 may be performed by one or more components of environment 200 of FIG. 2. However, while embodiments of the present disclosure are described in terms of environment 200 of FIG. 2, it should be recognized that other systems may be utilized to perform the described method. One of skill in the art will appreciate that this flowchart explains a typical example, which can be extended to advanced applications or services in practice.

Method 300 typically starts at block 305 where a dependency responder receives a GET URI dependencies request from a client device. The GET URI dependencies request may be transmitted by a user prior to transmitting an API request. This may allow for automatic and/or manual resolution of dependency issues prior to submission of the API request. The method proceeds to block 310 where the dependency responder may transmit the GET URI dependencies request to a dependency generator.

The method proceeds to block 315 where the dependency generator may retrieve one or more dependencies associated with the resource in the GET dependencies request from a dependencies data store. The dependencies data store may include a mapping of a dependency to an API request and its expected value. The API request and/or resource may be mapped to one or more dependencies. The dependencies may also be mapped to one or more API requests and/or resources. The dependencies may also vary based on server configurations and can be updated in real-time. For example, instead of requiring both username and password prior to adding a local user, the server may be updated to only require a username. Accordingly, when the dependency is updated, the dependency API for REST transactions may identify the change to the dependency in real time. In addition, after retrieving the dependencies, the dependency generator may transmit one or more dependencies to a dependency engine which may then determine whether one or more dependencies are met at block 320. For example, the dependency engine may determine a secure boot setting of the information handling system. The method proceeds to block 325.

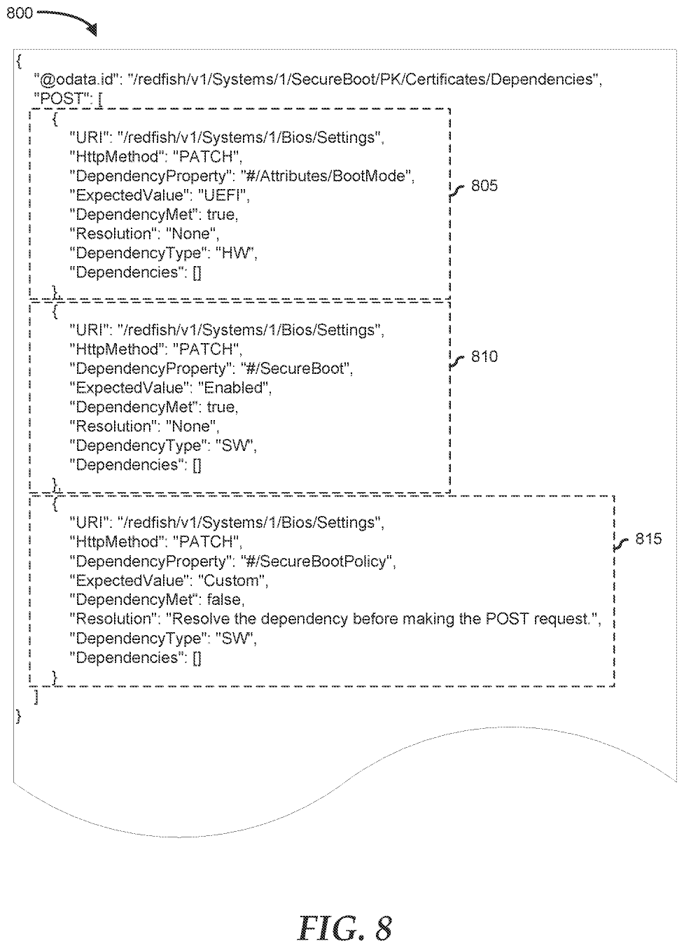

At block 325, the dependency generator may generate a response that includes information associated with the dependencies. For example, the response may include resolution(s) for unmet dependencies. The response may be formatted in one of various formats, such as in a JavaScript Object Notation, Extensible Markup Language, or other suitable formats. The dependency generator may provide the response to the dependency responder. The method proceeds to block 330 where the dependency responder may transmit a response, such as response 800 of FIG. 8, to the GET URI dependencies request.

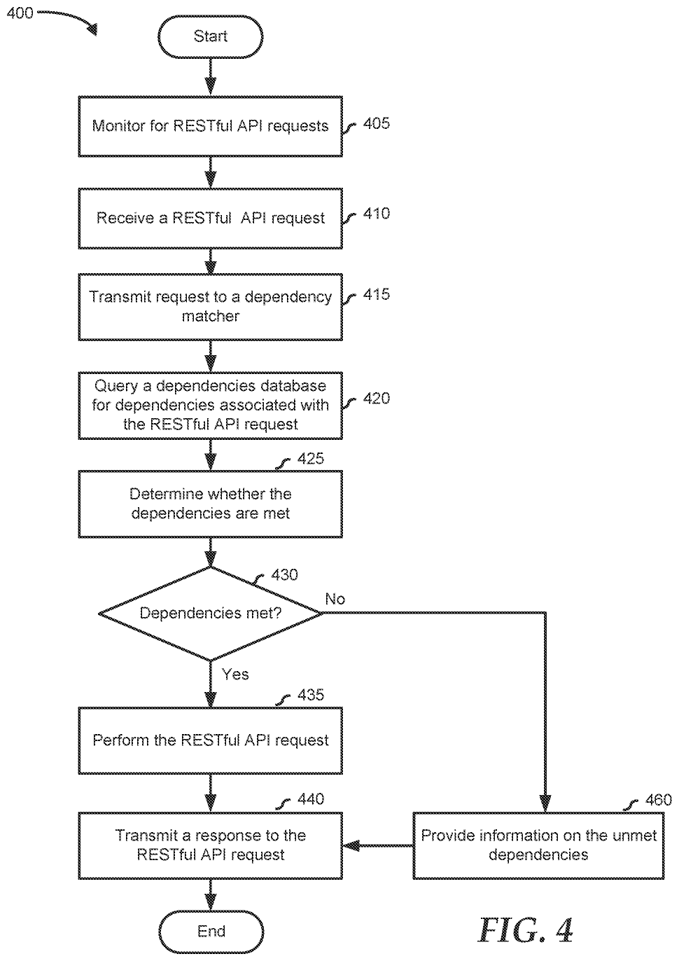

FIG. 4 shows a flowchart of a method 400 for dependency API for REST transactions. Method 400 may be performed by one or more components of environment 200 of FIG. 2. However, while embodiments of the present disclosure are described in terms of environment 200 of FIG. 2, it should be recognized that other systems may be utilized to perform the described method. One of skill in the art will appreciate that this flowchart explains a typical example, which can be extended to advanced applications or services in practice.

Method 400 typically starts at block 405 where an API request responder monitors for RESTful API requests. At block 410, the API request responder receives an API request. In one example, the API request responder receives a POST API request which can include a payload. The API request responder may also be configured to process other types of API requests. The method proceeds to block 415 where the API request responder may transmit the API request to a dependency matcher. The method proceeds to block 420 where the dependency matcher may query a dependency store or database to determine one or more dependencies associated with the API request. For example, the POST API request received is to create a user account. Dependencies to process this request may include a BIOS setting property secure boot set to enabled.

The dependency matcher may transmit one or more dependencies to a dependency engine. The method proceeds to block 425, where the dependency engine may process one or more dependencies to determine whether one or more dependencies are met. For example, the dependency engine may query the BIOS settings' secure boot property. The method may proceed to decision block 430, where the dependency engine may determine whether each one of the dependencies is met. If each one of the dependencies is met, then the “YES” branch is taken, and the method proceeds to block 435. If one of the dependencies is not met, then the “NO” branch is taken, and the method proceeds to block 460. At block 435, because one or more dependencies are met, the API request responder may perform or process the API request. The method proceeds to block 440, where the API request responder may transmit a response to the API request. Afterwards, the method ends.

At block 460, the API request responder may provide information on the unmet dependencies. For example, the API request responder may include the information in the response. Because the dependency is unresolved, then the API request may not be processed. The method may proceed to block 440.

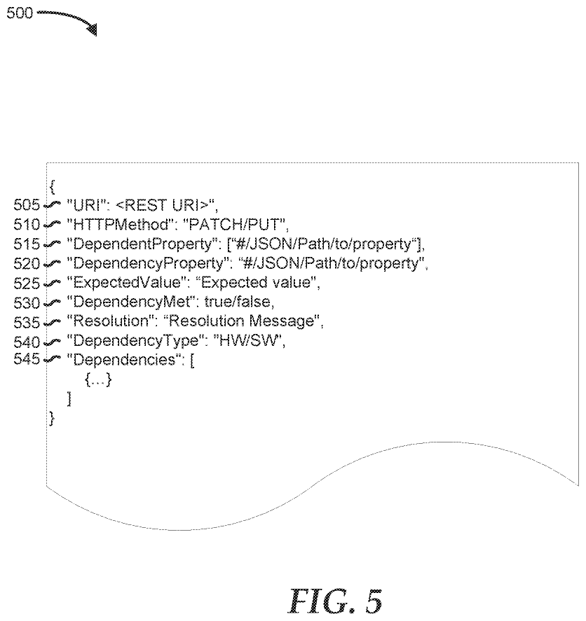

FIG. 5 is an example of a response 500 that shows a dependency API for REST transactions syntax. Response 500 is a response to a PATCH/PUT request that includes properties 505, 510, 515, 520, 525, 530, 535, 540, and 545. Property 505 includes a header “URI” and a URI that references a REST resource for the API request. The URI may be absolute. Property 510 includes the header “HTTP method” and a command “PATCH” or “PUT”. The PATCH or PUT command may be used to update an existing record associated with the resource. Other HTTP methods include a GET command, a POST command, and a DELETE command. The GET command returns the requested data. The POST command creates a new record while the DELETE command deletes an existing record.

Property 515 includes a header “DependentProperty” and a URI that references a path to a property of the resource to be updated. The path may be an absolute URI that references a property of the resource. The header-dependent property may be used at a property level when the dependency is for a PATCH or a PUT command to update a property of the resource. For example, a PUT API request is to update the username of a local user. Dependent property may include a username. Property 525 includes a header “ExpectedValue” and an actual value that is expected. Property 530 includes a header “DependencyMet” and a value of either true or false based on whether the dependency in property 520 was met or unmet. Property 535 includes a header “Resolution” and a value that includes information associated with a resolution of property 530.

Property 540 includes a header “Dependency Type” and a value of either “HW” for a hardware dependency or “SW” for a software dependency. A hardware dependency may be resolved by a hardware configuration while a software dependency may be resolved by a software configuration. As such, property 540 may indicate whether property 520 is a hardware or a software dependency. The hardware dependency type may be resolved via a hardware configuration while the software dependency type may be resolved via a software configuration. Property 545 includes a header “Dependencies” and one or more paths for nested dependencies if any. In this example, dependencies may include a password associated with the username.

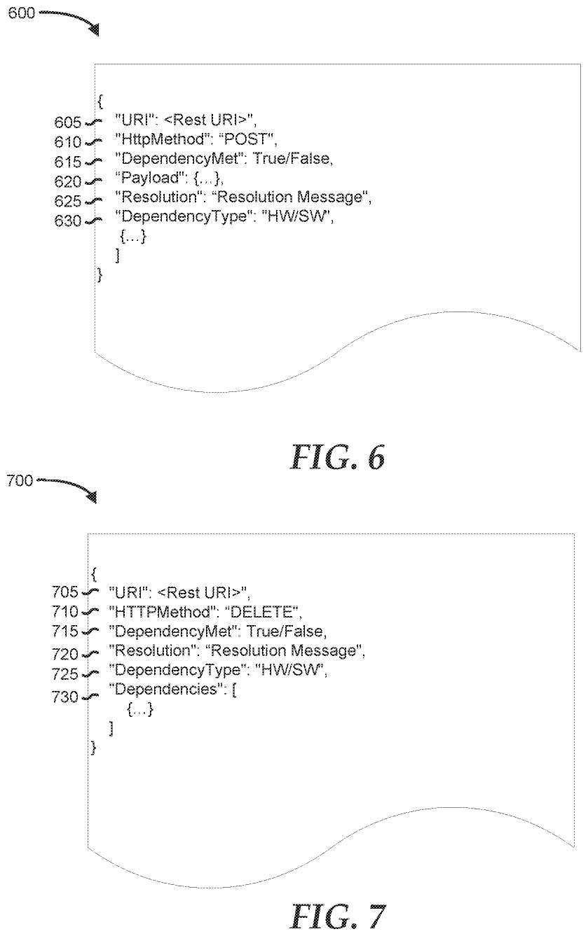

FIG. 6 is an example of a response 600 that shows a dependency API for REST transactions syntax. Response 600 is a response to a POST API request that includes properties 605, 610, 615, 620, 625, and 630. Property 605 includes a header “URI” and a path to a property of the resource to be created or posted. The path may be an absolute URI that references the resource. Property 610 includes a header “HTTPMethod” and a value “POST.” For example, the API request may be used to add the local user.

Property 615 includes a header “DependencyMet” and one of the values “true” or “false” based on whether a dependency was met. Property 620 includes a header “Payload” and data or information that is sent with the API request. Property 625 includes a header “Resolution” and information associated with a resolution of the dependency. Property 630 includes a header “DependencyType” and one of the values “HW” for hardware or “SW” for software dependency.

FIG. 7 is an example of a response 700 that shows a dependency API for REST transactions syntax. Response 700 which is a response to a DELETE API request includes properties 705, 710, 715, 720, 725, and 730. Property 705 includes a header “URI” and a path to a property of the resource to be deleted. The path may be an absolute URI that references the resource. Property 710 includes a header “HTTPMethod” and a value “DELETE.” Property 715 includes a header “DependencyMet” and one of the values “true” or “false” based on whether a dependency was met. Property 720 includes a header “Resolution” and information associated with a resolution of the dependency. Property 725 includes a header “Dependency Type” and one of the values “HW” for hardware or “SW” for software dependency. Property 730 includes a header “Dependencies” and one or more dependencies of the DELETE request.

FIG. 8 shows an example of a response 800 that includes information associated with a status of the dependencies of a POST API request. In one example, response 800 may be a portion of a response for the POST API request which is for importing a public key certificate. In this example, the response shows that the POST API request has three dependencies, such as a boot mode is set to UEFI, secure boot is enabled, and secure boot policy is set to custom. Response 800 was returned as part of a link response header. In this example, response 800 includes sections 805, 810, and 815. Section 805 shows information associated with the dependency property boot mode. Section 810 shows information associated with the dependency property secure boot. Section 815 shows information associated with the dependency property secure boot policy. In this example, dependency properties boot mode and secure boot were met. However, the dependency property secure boot policy property was unmet.

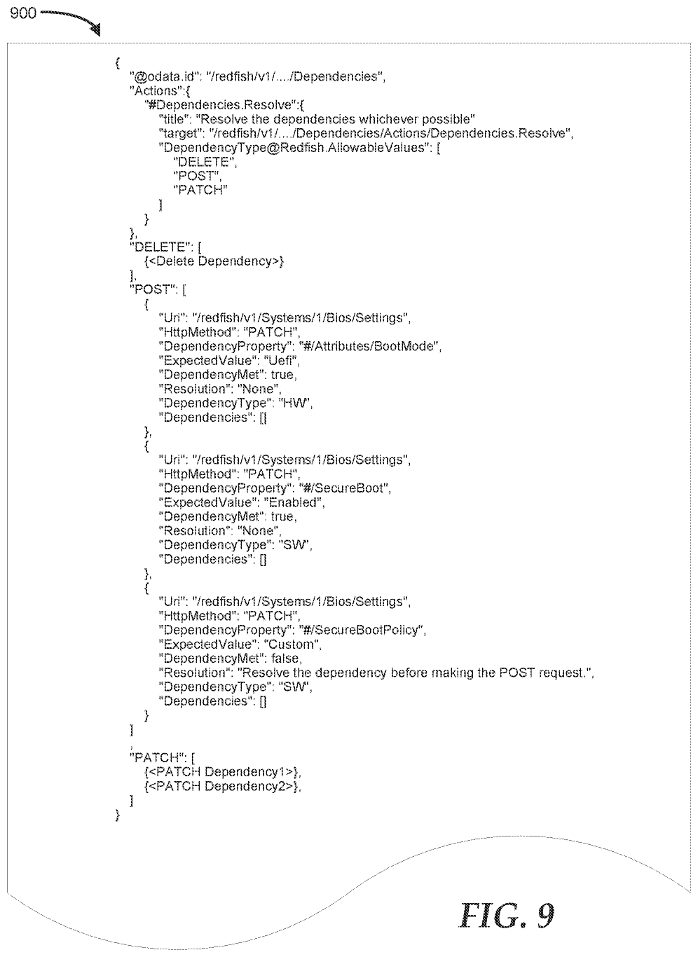

FIG. 9 shows an example of a response 900 portion that includes information associated with the resolution of unmet dependencies of an API request. In this example, three actions may be performed to resolve the unmet dependencies: DELETE, POST, and PATCH. Accordingly, a dependency resolution engine may determine which of the actions it can perform. For example, the dependency resolution engine may resolve software dependencies and process one or all of the DELETE, POST, and PATCH API requests related to a software dependency.

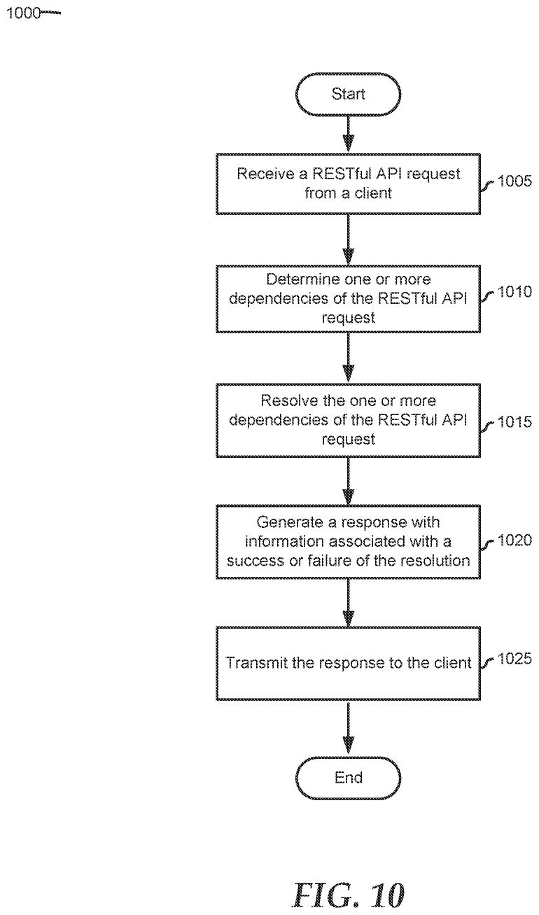

FIG. 10 shows a flowchart of a method 1000 for automatically resolving dependency issues of a RESTful API transaction. Method 400 may be performed by one or more components of environment 200 of FIG. 2. However, while embodiments of the present disclosure are described in terms of environment 200 of FIG. 2, it should be recognized that other systems may be utilized to perform the described method. One of skill in the art will appreciate that this flowchart explains a typical example, which can be extended to advanced applications or services in practice.

Method 1000 typically starts at block 1005 where the API request responder receives a RESTful API request to resolve dependencies from a client device. The API request may be a POST request such as:
URI: /redfish/v1/{API}/Dependencies/Actions/Dependencies.Resolve
Payload: {“DependencyType”: “PATCH”}

The API in the URI of an example POST request above may be a RESTful API whose dependencies are to be resolved. The API request responder may transmit the received API request to the dependency matcher. The method may proceed to block 1010 where the dependency matcher may determine one or more dependencies of the RESTful API identified in the URI of the request. For example, the dependency may query a dependency store to determine the one or more dependencies associated with the RESTful API. The dependency matcher may transmit one or more dependencies to the dependency resolution engine and/or the dependency engine.

The method may proceed with block 1015 where the dependency engine may determine whether the dependencies are unresolved, such as when the dependency met is set to false. For example, the dependency engine may query the configuration settings of the information handling system to identify unresolved dependencies if any. The dependency engine may transmit one or more dependencies that are not met to the dependency resolution engine which may determine whether the dependencies can be resolved. The dependency resolution engine may then resolve the unmet dependencies that can be resolved as applicable based on the resolution included in the information associated with the dependencies, such as in section 815 of FIG. 8. For example, the dependency resolution engine may update the secure boot setting of the information handling system according to the expected value. The dependency resolution engine may also download dependencies as applicable. In addition, The dependency resolution engine may also generate a response that includes the resolution(s).

The method may proceed to block 1020 where the dependency resolution engine may generate a response with information associated with the resolution. For example, the information may provide details on what resolution steps were performed and whether the resolution was successful or not. The response may be transmitted to the API request responder. The API request responder may then transmit the response to the client device at block 1025.

Although FIG. 3, and FIG. 4 show example blocks of method 300 and method 400 in some implementations, method 300 and method 400 may include additional blocks, fewer blocks, different blocks, or differently arranged blocks than those depicted in FIG. 3 and FIG. 4. Those skilled in the art will understand that the principles presented herein may be implemented in any suitably arranged processing system. Additionally, or alternatively, two or more of the blocks of method 300 and method 400 may be performed in parallel.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionalities as described herein.

When referred to as a “device,” a “module,” a “unit,” a “controller,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device).

The present disclosure contemplates a computer-readable medium that includes instructions or receives and executes instructions responsive to a propagated signal; so that a device connected to a network can communicate voice, video, or data over the network. Further, the instructions may be transmitted or received over the network via the network interface device.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes, or another storage device to store information received via carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although only a few exemplary embodiments have been described in detail above, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents but also equivalent structures.

What is claimed is:

1. A method comprising:
in response to receiving, by a processor, an application programming interface (API) request from a client, determining whether the API request has a dependency prior to processing the API request, wherein the dependency is based on a server configuration;
if the dependency is unmet, then resolving the dependency prior to processing the API request; and
if the dependency is resolved, then transmitting a response to the client based on the processing of the API request that includes information associated with the dependency.

2. The method of claim 1, further comprising querying the server configuration associated with the dependency.

3. The method of claim 1, wherein the dependency is met if a server configuration value is an expected value of the dependency.

4. The method of claim 1, wherein the API request is representational state transfer-compliant.

5. The method of claim 1, wherein the response is in JavaScript Object Notation format.

6. The method of claim 1, further comprising if the dependency is unresolved, then not processing the API request.

7. The method of claim 1, further comprising querying a dependency store to determine the dependency associated with the API request.

8. The method of claim 7, wherein the dependency store includes a database of a mapping of the API request to the dependency.

9. An information handling system, comprising:
a processor; and
a memory storing instructions that when executed causes the processor to perform operations including:
in response to receiving an application programming interface (API) request from a client, determining whether the API request has a dependency prior to processing the API request, wherein the dependency is based on a server configuration;
if the dependency is unmet, then providing an override for resolving the dependency manually prior to processing the API request; and
if the dependency is resolved, then transmitting a response to the client based on the processing of the API request that includes information associated with the dependency.

10. The information handling system of claim 9, wherein the operations further comprise querying the server configuration associated with the dependency.

11. The information handling system of claim 9, wherein the dependency is met if a server configuration value is an expected value of the dependency.

12. The information handling system of claim 9, wherein the API request is representational state transfer-compliant.

13. The information handling system of claim 9, wherein the response is in JavaScript Object Notation format.

14. The information handling system of claim 9, wherein the API request includes a GET dependencies request.

15. A non-transitory computer-readable medium to store instructions that are executable to perform operations comprising:
in response to receiving an application programming interface (API) request, determining whether the API request has a dependency prior to processing the API request, wherein the dependency is based on a server configuration;
if the dependency is unmet, then resolving the dependency prior to processing the API request; and
if the dependency is resolved, then transmitting a response based on the processing of the API request that includes information associated with the dependency.

16. The non-transitory computer-readable medium of claim 15, wherein the operations further comprise querying the server configuration associated with the dependency.

17. The non-transitory computer-readable medium of claim 15, wherein the dependency is met if a server configuration value is an expected value of the dependency.

18. The non-transitory computer-readable medium of claim 15, wherein the API request is representational state transfer-compliant.

19. The non-transitory computer-readable medium of claim 15, wherein the response is in JavaScript Object Notation format.

20. The non-transitory computer-readable medium of claim 15, wherein the API request includes a GET dependencies request.
